(19) United States
(12) Patent Application Publication
(10) Pub. No.: US 2012/0028744 A1
(43) Pub. Date: Feb. 2, 2012

(54) BELT TENSIONING UNIT

(75) Inventors: Bernd Hartmann, Weisendorf (DE); Thorsten Liebel, Furth (DE); Johann Singer, Grossenseebach (DE); Christine Thomann, Bad Windsheim (DE)

(73) Assignee: SCHAEFFLER TECHNOLOGIES GMBH & CO. KG, Herzogenaurach (DE)

(21) Appl. No.: 13/262,731

(22) PCT Filed: Apr. 26, 2010
(86) PCT No.: PCT/EP2010/055500

§ 371 Date: Oct. 3, 2011

(30) Foreign Application Priority Data
May 9, 2009 (DE) 10 2009 020 589.6

(51) Int. Cl. F16H 7/12

(52) U.S. Cl. 474/135

(57) ABSTRACT

A belt tensioning unit (1) having a rotatably fixed base part (2) and a tensioning part (3) which can be rotated in a limited manner in relation to the base part against the action of an energy storage unit (6) is provided. Between the base part (2) and the tensioning part (3) a friction device (8) is radially arranged between the energy storage unit (6) and a friction surface (10). The friction device is pre-tensioned by the energy storage unit (6) in a radial outward direction against the friction surface (10) when the base part (2) and the tensioning part (3) are rotated in relation to each other. In order to obtain a simple friction device (8) having improved friction properties, it is proposed to design the friction device (8) as a friction segment (9) that encloses two friction surfaces arranged symmetrically to each other and opposite of each other at the friction surface (10).

### BACKGROUND

The invention relates to a belt tensioning unit, in particular, for a belt-pulley section of an internal combustion engine, containing a base part arranged locked in rotation and a tensioning part that can rotate to a limited extent relative to this base part against the effect of an energy accumulator, wherein a friction mechanism is active between the base part and the rotating part.

Typical constructions of class-forming belt tensioning units have a tensioning part with a tensioning roller biased against a traction element. The tensioning part here can be rotated to a limited extent against the effect of an energy accumulator so that it can pivot relative to the base part arranged rigidly on a housing of the internal combustion engine. In this way, on one hand, vibrations introduced by pivoting of the tensioning roller into the traction mechanism drive equipped with the belt tensioning unit are damped and, on the other hand, the tension of the traction element, for example, a belt, is held constant also for elongation over the service life of the traction element. For the efficient damping of vibrations it is further advantageous to superimpose a friction hysteresis on the energy accumulator, with this hysteresis being set by means of a friction mechanism.

DE 10 2004 047 422 A1 discloses a belt tensioning unit according to the class with a base part and a tensioning part. The energy accumulator active between these parts during rotation is formed by a torsion spring that is tensioned at one end in the base part and at the other end in the tensioning part, so that for a relative rotation in one direction of rotation, the torsion spring expands and the friction mechanism is loaded with a normal force. The friction mechanism is here formed in two parts from a single-part friction ring that is open on one side and forms a friction engagement with a friction face of the base part when loaded by the torsion spring under expansion of the open ends. Between the torsion spring and the friction ring, the second part is arranged in the form of a band spring. Due to the construction of the friction ring that is open on one side, a non-symmetrical contact of the friction ring is realized on the friction face. In this way, non-uniform friction moments across the angle of rotation and a non-uniform wear of the friction lining can occur that must be compensated by a corresponding thickness of the friction lining.

WO 03/098971 A1 discloses a damping mechanism for a belt tensioning unit with a friction mechanism in which two ring segments divided across the periphery are proposed that are inherently stiff in terms of its diameter due to a solid carrier part and allow no adaptation of the diameter. An adaptation to the wear of the friction lining is carried out by an articulated connection between the two opposing ring segments, wherein this connection does not allow kinematically symmetric wear compensation, so that the friction linings of the ring segments are worn unequally and a corresponding wear reserve for the preferably worn area must be provided. Furthermore, the ring segments require a large installation space due to their solid construction and produce, due to their material accumulation, a heat accumulator that can endanger the resistance of the friction lining during heating.

### SUMMARY

Therefore the objective is to provide a belt tensioning unit whose friction mechanism forms, over the service life, for a comparatively thin construction of the friction linings, a uniform friction engagement with the friction face provided for the friction linings. In addition, the friction mechanism should be easy to produce and have low installation-space requirements.

According to the invention, this objective is met by a belt tensioning unit, especially for a belt-pulley section of an internal combustion engine with a base part arranged locked in rotation and a tensioning part that can rotate to a limited extent relative to this base part against the effect of an energy accumulator, wherein, between the base part and the tensioning part, a friction mechanism biased radially outward against a friction face by the energy accumulator for a relative rotation between the base part and tensioning part is arranged radially between the energy accumulator and the friction face. The friction mechanism is formed from a circular-segment-shaped friction segment that is arranged on the friction face and has an elastic construction in terms of its diameter.

Through the elastic construction of the friction segment, this can be applied to the friction face completely and independently of wear of the friction linings, so that a reproducible coefficient of friction and thus uniform friction moments can be formed. This setup also allows a uniform loading of the entire periphery of the friction segment by an outer periphery of the energy accumulator constructed preferably as a torsion spring, so that, across the inner periphery of the friction segment, a uniformly distributed normal force is achieved for forming the friction engagement with the friction face.

According to one advantageously constructed embodiment, the friction face is provided on an inner peripheral face of the base part. To achieve a sliding friction, such as Coulomb friction, in the rotation of the base part and tensioning part, a rotation of the friction segment relative to the friction face is forced, in that the friction segment is entrained by the tensioning part. In specially constructed embodiments, a friction engagement can be displaced by carrying out entrainment with play. As an alternative to the friction face provided on the base part, a corresponding friction face forming a friction engagement with the friction segment can be provided on the tensioning part, wherein this is mounted in the base part, in order to achieve a sliding friction for the rotation of the tensioning part relative to the base part.

According to the inventive concept, the friction segment is formed from a carrier part and a friction lining fixed on this segment. Here, the friction lining can be deposited on the carrier part with a positive-fit and/or material-fit connection, in that it is riveted, locked, or formed with a positive fit, for example, injection-molded or bonded. Through different materials of the friction lining that could be formed from different plastics with different coefficients of friction and hardness values, wherein plastics with lubricating properties, such as perfluorocarbons, could be used, which could also be embedded in a stable matrix or could form copolymers with this matrix. Here, the friction components forming such a friction lining are freely selectable for forming a modular building set with the carrier parts that are structurally adapted, in turn, to the conditions of use in the belt tensioning unit.

The carrier parts are punched, for example, from thin spring steel and pre-bent to the diameter of use, wherein, according to the desired construction of the friction engagement with the friction surface, the carrier parts could have a larger, approximately equal, or smaller diameter or radius than the friction face. For example, for achieving a biasing tension of the friction segment relative to the friction face, a biased friction engagement can be set if the diameter of the carrier part is selected larger than the diameter of the friction face, while, for smaller diameters, a friction engagement is completely produced only when the torsion spring exerts a corresponding normal force on the friction segment. Accordingly, the carrier parts could be brought to the desired diameter under plastic deformation before installation. It is understood that the carrier parts could be prefabricated first from soft sheet material and then could be subjected to hardening processes for achieving elastic properties.

For the rotational entrainment of the friction segment by the tensioning part or the base part for arrangement of the friction face on the tensioning part, at least one, advantageously a single, central flap in terms of the circular arc of a friction segment can be set off from the carrier part. This at least one flap engages in a recess provided in the base part or tensioning part, so that a corresponding rotational entrainment of the friction segment is carried out. Preferably, such a flap is set off radially inward. Through corresponding design of the size and shape of the cutout, the flap could be folded so that this could have a multiple-layer construction and thus could be reinforced.

As an alternative to a construction made from spring steel, the carrier parts could be produced from plastic, preferably from reinforced plastic. Such carrier parts are preferably produced by a plastic injection-molding process, wherein the at least one flap for entrainment of the friction segment is provided as an off-tool part. Furthermore, for carrier parts produced in this way in a two-component or multiple-component method, the friction lining could be already applied, such as sprayed on, so that the friction segments are produced in one piece and as an off-tool part completely from at least two plastic components—one component advantageously made from reinforced plastic for forming the carrier part and a second component made set to the desired coefficient of friction.

For setting the desired friction moments, in addition to the design of the friction lining, the structure and the material selection of the friction face are also considered. Here, the use of metal faces, for example, unprocessed extruded aluminum faces, has proven especially advantageous.

Through a construction of the carrier parts from thin sheet metal or thin, reinforced plastic or the like, the heat capacity of the friction segment can be minimized, so that heat is dissipated quickly to the surrounding parts, for example, the base part, and there is no heat accumulation in the carrier parts that could have a disadvantageous effect on the service life of the friction linings, so that, overall, a longer service life of the friction segments could be expected.

According to the inventive concept, the single-part friction segment is supported across two diametrically arranged areas on the circular-round friction face, wherein these areas preferably have an arc with an angle between 90° and 150°. Here, depending on the diameter of the friction face, a diameter of the friction segment between 35 mm and 70 mm has proven advantageous.

The flaps of the friction segment could be constructed corresponding to the installation geometry. Here it has been shown to be advantageous when the flaps are provided in the center between the two end sides of the carrier parts, because in this way the friction segment of a belt tensioning unit can be constructed.

According to the invention, the objective is further met by a friction mechanism that is formed from two circular-segment-shaped friction segments that are symmetric to each other and are arranged opposite the friction face and have elastic constructions in terms of their diameter. One preferred construction provides that the two circular-segment-shaped friction segments are formed as the same parts.

According to the inventive concept, two friction segments arranged diametrical to the circular friction face are provided that preferably assume an arc with an angle between 90° and 150°. Here, depending on the diameter of the friction face, a diameter of the friction segments between 35 mm and 70 mm has proven advantageous. The flaps of the friction segments could be constructed according to the installation geometry. Here it has been shown advantageous when the flaps are provided in the center between the two end sides of the carrier parts, because in this way the two friction segments of a belt tensioning unit could be constructed as the same parts, so that lower logistic and tool costs could be achieved.

### BRIEF DESCRIPTION OF THE DRAWINGS

The invention will be explained in more detail with reference to the embodiments shown in FIGS. 1 to 2d. Shown herein are:

FIG. 1 a section through a belt tensioning unit with a friction mechanism that comprises friction segments,

FIGS. 2a to 2d different views of a friction segment with a carrier part made from sheet metal and a friction lining.

### DETAILED DESCRIPTION OF THE PREFERRED EMBODIMENTS

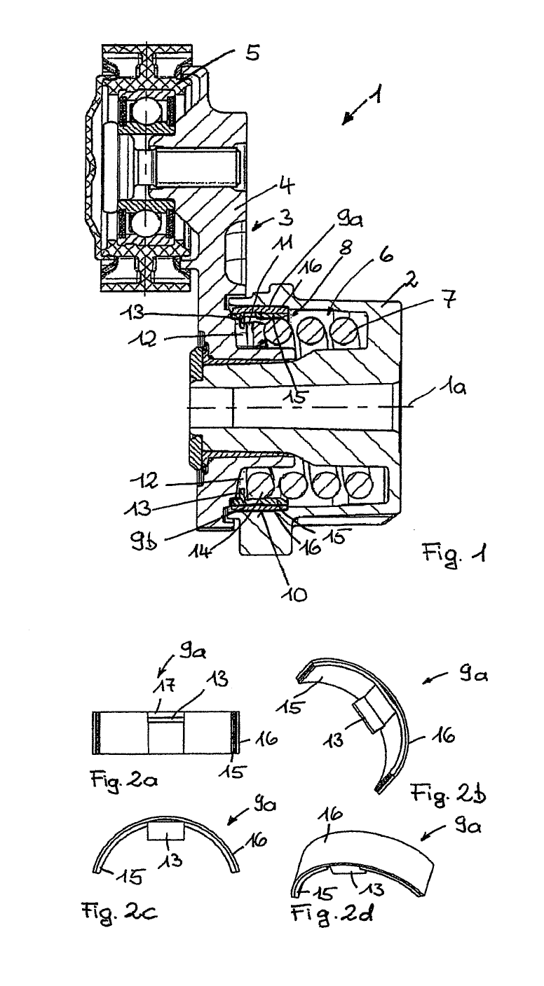

FIG. 1 shows a belt tensioning unit 1 for a traction mechanism drive with a stationary base part 2 attached, for example, to a housing of an internal combustion engine and a tensioning part 3 that can be displaced to a limited extent relative to this base part about the axis of rotation 1a, wherein this tensioning part is constructed here as a pivot arm 4 that holds the tensioning roller 5 in a rotatable manner. The tensioning roller 5 engages in the traction element, for example, a belt, and adjusts its bias and damps vibrations introduced into the traction mechanism drive by a pivoting of the pivot arm 4. A force compensating the tension of the traction element is here provided between the base part 2 and the pivot arm 4 by an energy accumulator 6 tensioned between these parts. In the illustrated embodiment, this is formed by a torsion spring 7 that is tensioned by means of entrainment mechanisms on its one end in a rotationally locked manner with the base part 2 and on its other end in a rotationally locked manner with the pivot arm 4, wherein, in FIG. 1, only the entrainment mechanism 11 of the pivot arm 4 formed in the direction of the torsion spring 7 is visible.

For damping vibrations that occur in the traction mechanism drive and that load the friction tensioning unit 1 due to more or less rhythmic pivoting movements of the pivot arm 4, during a rotation, such as a partial rotation or pivoting of the pivot arm 4 relative to the base part 2, a friction mechanism 8 is engaged that is formed from one of friction segments 9 and a complementary friction face 10 provided on the inner periphery of the base part 2. Here, the friction segment 9 is entrained for a relative rotation between pivot arm 4 and base part 2 by the pivot arm 4 by another entrainment mechanism 12 that is provided on the pivot arm 4 and can also be formed in a simpler construction by the entrainment mechanism 11 for the helical spring. This engages axially in the friction segment 9 and entrains this with a rotational lock on the flap 13 set off radially inward. Here—as shown—the flap 13 could be entrained by the entrainment mechanism 12 in the peripheral direction, wherein the flap 13 engages axially in an entrainment mechanism 12 constructed as a recess and is therefore entrained in both rotational directions. In other advantageous embodiments, the entrainment mechanism could be constructed as a cam around which the flap 13 is folded. Here, the flap 13 could be pre-folded and pushed onto the cam during assembly. Alternatively, the sides of the flap 13 could be bent during assembly. In both cases, an undercut could be provided on the cam, with this undercut cutting under a part of the flap for forming a captive connection or an axial fixing of the friction segment 9 on the base part 2, in that the flap 13 is bent or engaged accordingly.

The friction segment 9 could be constructed under biasing or with little air clearance relative to the friction face 10. The loading of the friction segment 9 relative to the friction face 10 is carried out by a normal force of the torsion spring 7 that expands during a rotation of the pivot arm 4 relative to the base part 2. Here, one or more windings 14 of the torsion spring 7 are applied to the inner periphery of the friction segment 9 and define, through the normal force of the torsion spring 7 acting on these windings, the friction moment increasing with the rotational angle of the pivot arm 4 between the friction segment 9 and the friction face 10, that is, between the pivot arm 4 and the base part 2.

The friction segment 9 encloses two areas or zones that are arranged diametrically opposed to each other on the friction face 10 and are constructed as a friction lining 16. Due to the special loads and requirements, a carrier part 15 connects the friction linings 16 for forming a single-part friction segment 9. The carrier part 15 is here produced from a mechanically loadable material in which neither the torsion spring 7 nor the entrainment mechanism 12 of the pivot arm 4 can be embedded. For example, the carrier part 15 could be produced from spring steel or from reinforced plastic. The carrier part 15 is here constructed as a flat component considered in the radial direction for minimizing the heat storage capacity and the required installation space. The friction lining 16 is designed for the setting of an optimized coefficient of friction with the friction face 10 and is therefore formed from soft plastic, such as, polyamide or another friction material that does not have to mechanically withstand the normal forces of the torsion springs 7 due to the support by the carrier part 15.

FIGS. 2a to 2d show the friction segment 9 as an individual part in different views. The friction segment 9 is bent from the carrier part 15 produced from the spring steel sheet metal set to a diameter of use, wherein the flap 13 is set out from this carrier part. In other embodiments, the flap could be constructed from a closed window cutout, so that, on both ends of the carrier part 15, a connecting piece 17 remains for the additional stabilization of the carrier part, wherein the carrier part is also stabilized. Through additional—not shown—cutouts in the peripheral direction, the flap 13 could have a multiple-layer construction in other embodiments by turning over these cutouts and thus could be reinforced. On the outer periphery of the carrier part 15, the friction lining 16 is deposited, for example, bonded or connected to this part in a positive-fit connection, for example, by a locking part, in a way that is not shown.

### LIST OF REFERENCE SYMBOLS

1 Belt tensioning unit
1a Axis of rotation
2 Base part
3 Tensioning part
4 Pivot arm
5 Tensioning roller
6 Energy accumulator
7 Torsion spring
8 Friction mechanism
9 Friction segment
10 Friction face
11 Entrainment mechanism
12 Entrainment mechanism
13 Flap
14 Winding
15 Carrier part
16 Friction lining
17 Connecting piece

1. Belt tensioning unit for a belt-pulley section of an internal combustion engine, comprising a base part arranged locked in rotation and a tensioning part that can rotate to a limited extent relative to the base part against an effect of an energy accumulator, wherein, between the base part and the tensioning part, a friction mechanism is located that is biased for a relative rotation between the base part and tensioning part by the energy accumulator outward in a radial direction against a friction face, the friction mechanism is located radially between the energy accumulator and the friction face, wherein the friction mechanism is formed from a circular-segment-shaped friction segment arranged on the friction face and has an elastic construction in terms of a diameter thereof.

2. Belt tensioning unit according to claim 1, wherein the friction face is formed on the base part and the friction segment is entrained by the tensioning part in a rotational direction.

3. Belt tensioning unit according to claim 1, wherein the friction segment is formed from a carrier part and a friction lining is fixed on the carrier part.

4. Belt tensioning unit according to claim 3, wherein the carrier part is punched from thin spring steel and a flap is offset radially inward for entrainment of the friction segment.

5. Belt tensioning unit according to claim 4, wherein the flap is reinforced by folding of offset sheet material.

6. Belt tensioning unit according to claim 3, wherein the carrier part is produced from reinforced plastic, and a flap for entrainment of the friction segment is provided as an off-tool part.

7. Belt tensioning unit according to one of claim 1 wherein the friction segment assumes an arc between 90° and 150°.

8. Belt tensioning unit according to one of claim 1, wherein the friction segment assumes a diameter between 35 mm and 70 mm.

9. Belt tensioning unit according to one of claim 1, wherein there are a plurality of the friction segments that are adjusted plastically to a smaller diameter than the friction face before installation in the belt tensioning unit.

10. Belt tensioning unit according to claim 1, wherein the friction mechanism formed from two circular-segment-shaped friction segments that are symmetric to each other and are arranged opposite the friction face and have an elastic construction in terms of their diameter.

11. Belt tensioning unit according to claim 10, wherein the friction segments arranged opposite each other symmetrically are identical parts.
